(19) United States
(12) Patent Application Publication
(10) Pub. No.: US 2014/0062049 A1
(43) Pub. Date: Mar. 6, 2014

(54) Opposed Triangulated 4-Link Suspension System

(71) Applicant: Ronald Scott Bandy, San Pablo, CA (US)

(72) Inventor: Ronald Scott Bandy, San Pablo, CA (US)

(21) Appl. No.: 13/586,458

(22) Filed: Aug. 29, 2012

(51) Int. Cl. B60G 9/02

(52) U.S. Cl. 280/124.116

(57) ABSTRACT

This is a novel suspension system comprised of four independent links where two links occupy one side of a solid axle and two links occupy the opposite side of a solid axle. One pair of links is directed from the axle towards the end of the vehicle and lies diagonal to the longitudinal axis of the vehicle. The other pair of links is directed from the axle towards the middle of the vehicle and lies diagonal to the longitudinal axis of the vehicle. By its very nature, this suspension system can be applied to both the front and rear solid axles of a four wheel drive (4WD) vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The automotive industry has seen many types of link-style suspension systems including ladder bar, torque arm, swing arm, three-link, and four-link suspension systems. Within the four wheel drive (4WD) community a coil sprung, coilover shock, or air-bag configured solid axle also requires a link-style suspension system. Those most widely used are the radius arm, three-link, and four-link. For example, Ford and Land Rover utilize a radius arm suspension system on their solid axle 4WD vehicles while Dodge Ram and Jeep utilize a four-link suspension system on their solid axle 4WD vehicles. Most link-style suspension systems need an additional link known as a Panhard bar or trackbar.

Currently, the preferred suspension system for solid axle 4WD vehicles is the triangulated 4-link suspension system. This is a suspension system consisting of four independent links where all links are located on the same side of an axle and where at least two links are angled. This preference is based on the observation that a triangulated 4-link suspension system is one of the best articulating suspension systems known. It also possesses the unique, and very important, characteristic of discarding the Panhard bar.

Articulation refers to the amount of vertical separation of an axle's wheels when the vehicle negotiates an obstacle. As the links are angled, they become more aligned with the axle. Greater alignment implies fewer propensities for the angled link to bind up in the bracket. During articulation, displacement of the angled links is minimized when one end of the link is attached to the center of the axle (viewing an articulated axle as a right triangle, displacement at the end of the axle is twice that at the center of the axle). Less displacement also implies fewer propensities for the angled link to bind up in the bracket. Less bind up in the bracket facilitates a greater amount of articulation by the wheels.

The Panhard bar is discarded because the angled links perform the Panhard bar's job of controlling the axle's lateral motion. While the Panhard bar imparts lateral motion, the angled links prevent it. When the suspension cycles up and down, the Panhard bar's rotational motion is reflected in a directly related lateral motion by the axle; whereas, under the same cyclic function the angled links hold the axle in a centered position beneath the vehicle. Although this lateral motion is not critical to a slow-moving off-road vehicle traversing rugged terrain, it can become problematic to a vehicle encountering un-even terrain at speed; e.g., street driving conditions. When attached to the steering front axle, a Panhard bar that is loose or worn out may transform this lateral motion into a harmonic oscillatory resonance known as “Death Wobble”. Death Wobble has been blamed for damage to the steering and suspension components on a vehicle.

These articulation and discarded Panhard bar features derive from the process of angling two of the four links in a triangulated 4-link suspension system. However during installation or cycling of this suspension system, the angled links may interfere with other components on a vehicle such as the engine, oil pan, gas tank, and exhaust. Thus, utilization of a triangulated 4-link suspension system is successful only when this interference is absent. In practice, absence of the interference is possible only for customized, purpose-built off-road vehicles and extraordinarily difficult for street driven vehicles.

In the late 1990s, builders of customized two wheel drive (2WD) trucks learned to circumvent this interference dilemma by moving the two angled links from the side of the axle where all four links are located to the opposite side of the axle. In so doing, they transformed the triangulated 4-link suspension system into a NEW suspension system where the two parallel links are on one side of the axle and the two angled links are on the other side of the axle. This new suspension system was popularly referred to as the 2-forward/2-reverse triangulated 4-link suspension system.

Although the 2-forward/2-reverse triangulated 4-link suspension system looks similar to the present invention, their design characteristics are very different. The 2-forward/2-reverse triangulated 4-link suspension system was designed for lowered 2WD trucks, and includes relatively short links and restricted travel/articulation properties; whereas, the present invention is designed for street-driven/“non-lifted” 4WD trucks, and includes relatively long links and unrestricted travel/articulation properties.

The 2-forward/2-reverse triangulated 4-link suspension system is shunned by the 2WD truck community due to its spotty/questionable street performance characteristics; whereas, the present invention is ideally suited for the 4WD truck community due to its utility for the street and promising off-road performance characteristics.

### BRIEF SUMMARY OF THE INVENTION

The present invention furnishes a suspension system that is structurally different from, yet functionally the same as, a triangulated 4-link suspension system. The triangulated 4-link suspension system is considered state of the art and utilized exclusively by customized, purpose-built off-road vehicles.

The present invention also furnishes a suspension system that:

is specifically designed to NOT interfere with other components (e.g.; engine, oil pan, gas tank, exhaust) on the vehicle and therefore is suitable for use on street driven/“non-lifted” solid axle 4WD vehicles;
is in principle one of the best articulating suspension systems available to the 4WD enthusiast;
is intended for front solid axle vehicles thereby eliminating the Panhard bar, and implicitly the incidence of “Death Wobble”;
is in principle superior to the suspension systems used by manufacturers of front and rear solid axle 4WD vehicles; e.g., Ford, Dodge Ram, Jeep, and Land Rover.
is equally adaptable to the front and rear solid axles in a 4WD vehicle.
is in particular easily adaptable to the front and rear solid axles comprised of link-style suspension systems such as those utilized by Jeep.
distributes the loads seen by the axle under hard acceleration and hard braking throughout the frame better than other link-style suspension systems, including triangulated 4-link suspension systems.
is constructed with adjustable brackets that contain a plurality of mounting points; and, with links whose lengths are adjustable and whose joints are flexible. Such adjustability permits the suspension installer to tune the suspension system for a variety of terrain and vehicle types.

### BRIEF DESCRIPTION OF THE SEVERAL VIEWS OF THE DRAWING

### List of Reference Numerals Utilized in the Drawings

10—frame
11—front differential housing
12—front axle tube
13—front upper link
14—front lower link
15—front axle truss
16—front upper link axle bracket
17—front upper link frame bracket
18—front lower link axle bracket
19—front lower link frame bracket
20—coil spring
21—shock absorber
22—rear differential housing
23—rear axle tube
24—rear upper link
25—rear lower link
26—rear upper link axle bracket
27—rear upper link frame bracket
28—rear lower link axle bracket
29—rear lower link frame bracket
30—selectable connection location

### BRIEF DESCRIPTION OF THE DRAWINGS

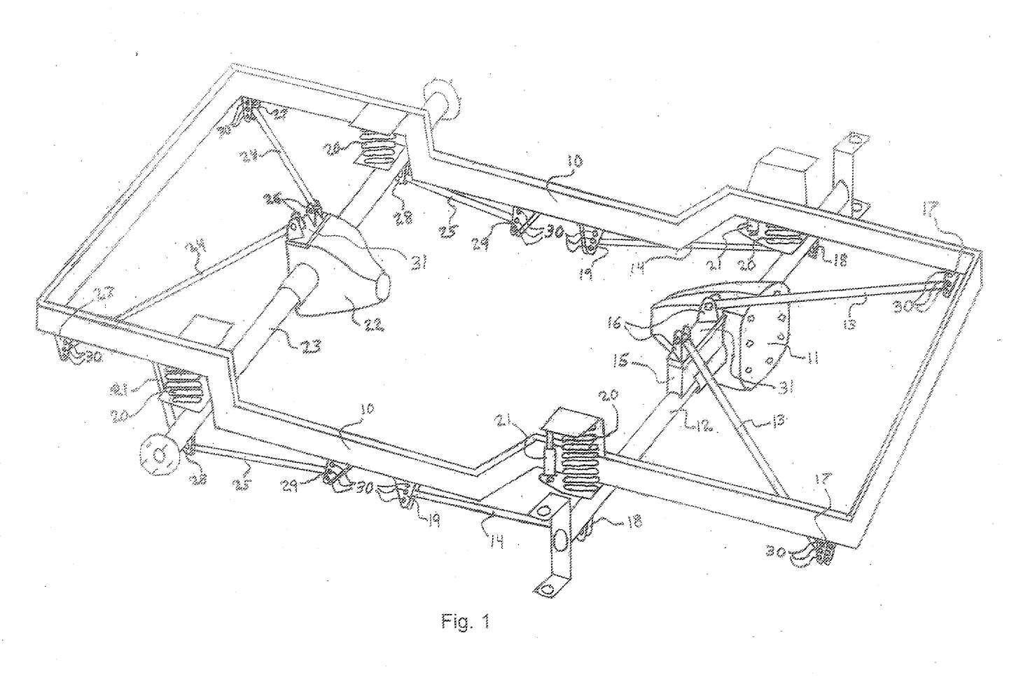

FIG. 1 is a front side perspective view of the front and rear suspension systems for a 4WD vehicle;

FIG. 2 is a top plan view thereof;

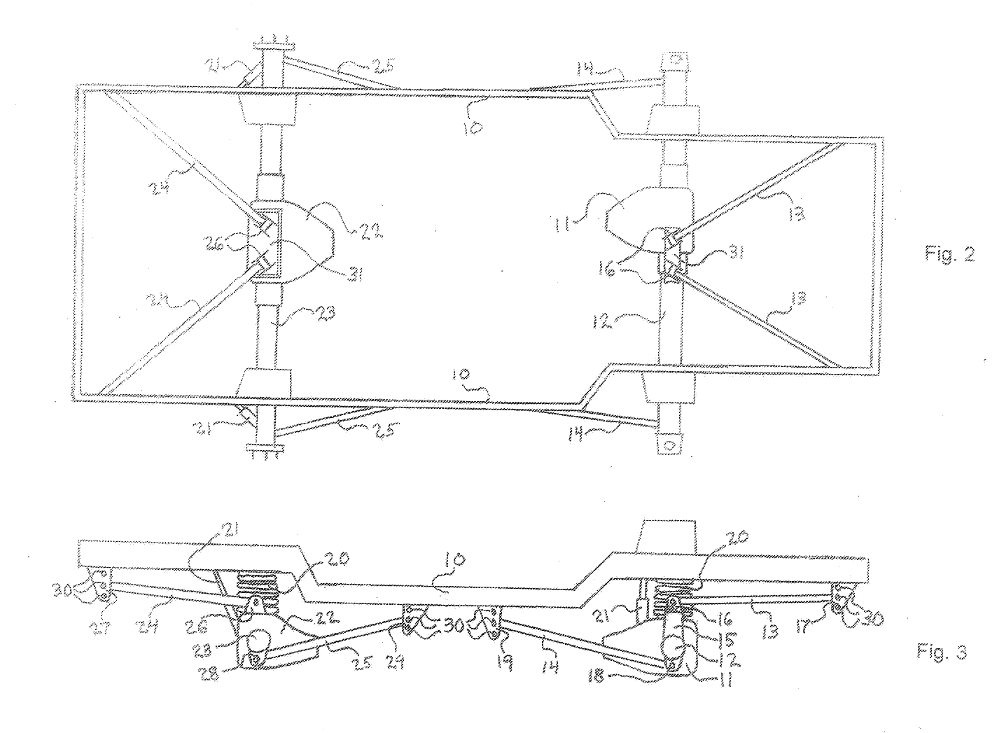

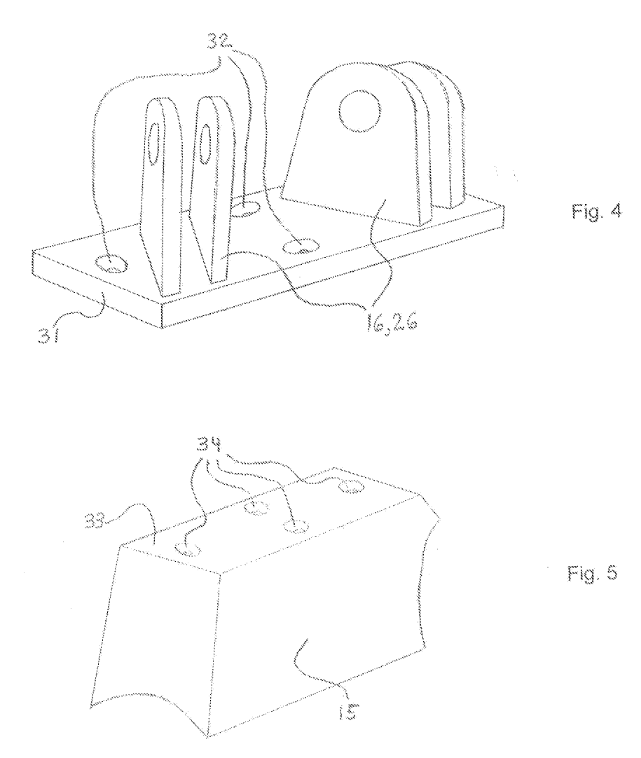

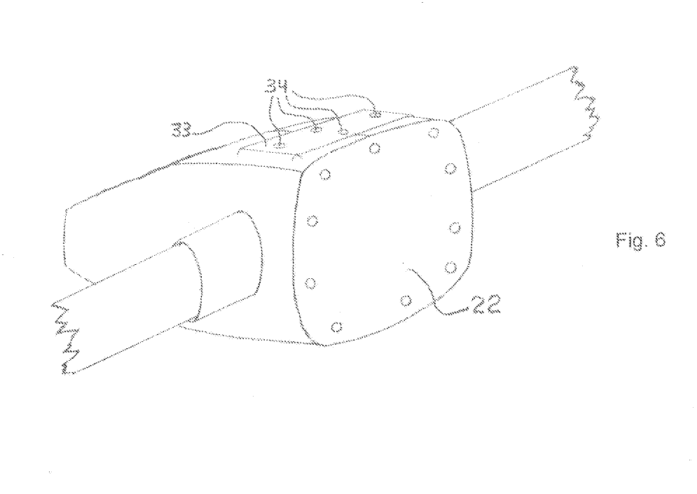

FIG. 3 is a side plan view thereof.

### DETAILED DESCRIPTION OF THE INVENTION

Referring to FIGS. 1, 2, and 3, there is shown a vehicle's frame 10 that is comprised of a combination of the front and rear suspension systems:

The front suspension system involves a front axle that is connected to the frame 10 with brackets 16, 17, 18, and 19 and links 13 and 14 where suspension damping is provided by a set of coil springs 20 and shock absorbers 21.

The front axle truss 15 is attached partway to the front differential housing 11 and partway to the front axle tube 12 thereby locating the front axle truss 15 in the center of the front axle. A pair of brackets 16 are attached to the top of the front axle truss 15 such that considering the brackets 16 as a single unit locates them at the center of the front axle truss 15 and thereto the center of the front axle. Brackets 17 are attached to the right and left sides of the frame 10 in front of the front axle. Brackets 18 are attached to the right and left sides of the front axle near the ends and at the bottom of the axle tube 12. Brackets 19 are attached to the right and left sides of the frame 10 behind the front axle. Brackets 17 and 19 have selectable connection locations 30 such that varying the connection point varies the load transfer distribution to the frame 10. This variance allows the suspension installer to tune the front suspension for specific characteristics.

Link 13 is connected to bracket 16 on one end and to bracket 17 on the other end, thereby adopting a diagonal geometry above and in front of the front axle and centrally locating the front axle beneath the vehicle at all times. Link 14 is connected to bracket 18 on one end and bracket 19 on the other end, thereby adopting a diagonal geometry below and behind the front axle and therefore reducing the effects of roll steer as the front suspension cycles up and down.

The rear suspension system involves a rear axle that is connected to the frame 10 with brackets 26, 27, 28, and 29 and links 24 and 25 where suspension damping is provided by a set of coil springs 20 and shock absorbers 21.

A pair of brackets 26 are arranged on the top of the rear differential housing 22 such that considering the brackets 26 as a single unit locates them at the center of the rear differential housing 22 and thereto the center of the rear axle. Brackets 27 are attached to the right and left sides of the frame 10 behind the rear axle. Brackets 28 are attached to the right and left sides of the rear axle near the ends and at the bottom of the axle tube 23. Brackets 29 are attached to the right and left sides of the frame 10 in front of the rear axle. Brackets 27 and 29 have selectable connection locations 30 such that varying the connection point varies the load transfer distribution to the frame 10. This variance allows the suspension installer to tune the rear suspension for specific characteristics.

Link 24 is connected to bracket 26 on one end and to bracket 27 on the other end, thereby adopting a diagonal geometry above and behind the rear axle and centrally locating the rear axle beneath the vehicle at all times. Link 25 is connected to bracket 28 on one end and bracket 29 on the other end, thereby adopting a diagonal geometry below and in front of the rear axle and therefore reducing the effects of roll steer as the rear suspension cycles up and down.

### Materials for Construction of the Present Invention

A. Brackets and Truss
1. Constructed from steel plate of at least 3/16″ wall thickness;
2. Shape and dimensions are dependent on where and how they are located on the frame or axle;
3. The top of the truss must be large enough to accommodate the mounting of the two front upper link axle brackets;
4. The rear upper link axle brackets are an integral part of the rear differential housing casting.

B. Links
1. Constructed from 1020-1026 DOM tubing. Links made from 7075-T6 aluminum or 4130 steel (chromoly) are also acceptable;
2. Dimensions for DOM tubing should be at least 1.75″OD×0.250″wall thickness for a link length of 36″ or less. For longer links, above dimensions should be increased to maintain structural integrity;
3. Link ends should be either tapped or bungs (tubing inserts) welded in so as to accept threaded joints.

C. Joints
1. Must be flexible—either cartridge style flex joints or spherical rod ends. Examples include Ballistic Joints©, Johnny Joints©, Summitmachine flex joints, and heim joints;
2. Must have threaded shanks;
3. Weld-on rubber or urethane joints are acceptable for one end of the link only. Must be equivalent to original equipment manufacturer bushing; e.g., clevite mechanically bonded bushing. These joints are used to isolate road noise and vibration.

D. Fasteners
1. Are bolts and nuts that should be fine threaded of Grade 8 rating;
2. Should be at least 9/16″ size;
3. The length of a bolt is dependent on the dimensions and type of bracket and joint involved in the connection that the bolt will make.

Installation of the Present Invention
1. Brackets and truss should be welded on for maximum strength. Bolt-on is acceptable if they can withstand the loads they are projected to encounter;
2. Attach brackets such that:
   (a) all links are as long as is reasonably possible, where each link per pair (i.e., left and right) is the same length;
   (b) upper links have an angle of at least 30° relative to the vehicle centerline, where each link per pair has the same angle;
   (c) upper links are as parallel with the ground as is reasonably possible where each link per pair has the same angle;
   (d) lower links have an angle of about 8° relative to the vehicle centerline, where each link per pair has the same angle and the frame brackets are closer to the centerline than are the axle brackets;
   (e) the instant center (IC) is close to the front bumper;
   (f) both anti-squat (AS) and anti-dive (AD) are at 65%±5;
3. Utilize a 4-link calculator program that is configured for a triangulated 4-link suspension system to calculate IC, AS, and AD;
4. The objective is to install the present invention such that the vehicle has neutral handling characteristics.

While the invention has been illustrated and described as embodied in a vehicle suspension system, it is not intended to be limited to the details shown, since it will be understood that various omissions, modifications, substitutions and changes in the forms and details of the device illustrated and in its operation can be made by those skilled on the art without departing in any way from the scope and spirit of the present invention.

1. (canceled)

2. A vehicle front and rear suspension systems of claim 7, wherein the inner and outer ends of each link refer to a flexible joint that enables the link to move freely in any direction.

3. A vehicle front and rear suspension systems of claim 7, wherein the inner and outer ends of each link comprise a flexible joint that is connected to the mounting bracket with a fastener; wherein each mounting bracket that is attached to the frame has a plurality of adjustment openings for adjusting the connecting points with the links; wherein the dimensions of the mounting brackets in one bracket assembly are able to be different from those in another bracket assembly, thereby replacing one bracket assembly with another represents an adjustable mounting bracket for the upper links.

4. A vehicle front and rear suspension systems of claim 7, wherein the truss, configured with the bracket assembly affixed atop its structure, is attached to the front axle at its center-point thereby positioning the bracket assembly at the center-point of the front axle such that the inner ends of the left and right upper links are adjacent to the vehicle centerline in the front suspension system; wherein the bracket assembly is affixed to the truss by passing fasteners through its multiple smooth holes and screwing them into the multiple threaded holes in the top of the truss.

5. A vehicle front and rear suspension systems of claim 7, wherein the rear differential housing, configured with the bracket assembly affixed atop its structure, is located in the rear axle at its center-point thereby positioning the bracket assembly at the center-point of the rear axle such that the inner ends of the left and right upper links are adjacent to the vehicle centerline in the rear suspension system; wherein the bracket assembly is affixed to the rear differential housing by passing fasteners through its multiple smooth holes and screwing them into the multiple threaded holes in the top of the rear differential housing.

6. A vehicle front and rear suspension systems of claim 3, wherein the frame mounting brackets are able to be attached to a transmission cross-member or other cross-members found on the frame which can be of a ladder or tubing construction that is typically utilized on four wheel drive vehicles.

7. A vehicle front and rear suspension systems for a vehicle having a frame with respective frame sides and suspended above solid axles, the vehicle front and rear suspension systems comprising:
left and right upper links;
left and right lower links;
a front solid axle having a differential housing;
a rear solid axle having a differential housing;
a front axle truss having a top structure, the top structure being machined to a flat surface with multiple threaded holes;
the rear differential housing having a top structure, the top structure being machined to a flat surface with multiple threaded holes;
a bracket assembly having mounting brackets welded to a metal plate, the metal plate being machined to a flat surface with multiple smooth holes;
mounting brackets, each being attached to the respective frame side, axle, or bracket assembly thereby serving as connection locations for links;
wherein the left and right upper links extend from the axle to an end of the vehicle, each link having inner and outer ends that are pivotally connected to mounting brackets, the mounting brackets for the inner ends of the links being attached to the bracket assembly and the mounting brackets for the outer ends of the links being attached to the respective frame sides, the bracket assembly being positioned at a center-point of the axle such that the inner ends of the links are closer to a vehicle centerline than the outer ends of the links;
wherein the left and right lower links extend from the axle to a middle of the vehicle, each link having inner and outer ends that are pivotally connected to mounting brackets, the mounting brackets for the inner ends of the links being attached to the respective frame sides and the mounting brackets for the outer ends of the links being attached to the axle such that the inner ends of the links are closer to the vehicle centerline than the outer ends of the links.
